(19) United States
(12) Patent Application Publication
(10) Pub. No.: US 2015/0135919 A1
(43) Pub. Date: May 21, 2015

(54) METHOD OF SEVERING H-BEAMS BY HORIZONTAL BAND SAW MACHINE, CONTROL UNIT, AND HORIZONTAL BAND SAW MACHINE

(71) Applicant: Daito Seiki Co., Ltd., Hyogo (JP)

(72) Inventors: Mitsuo Kondo, Hyogo (JP); Koji Miyamoto, Hyogo (JP)

(21) Appl. No.: 14/398,593

(22) PCT Filed: May 30, 2013
(86) PCT No.: PCT/JP2013/065638

§ 371 Date: Nov. 3, 2014

(30) Foreign Application Priority Data
Jun. 11, 2012 (JP) 2012-131899
Jun. 15, 2012 (JP) 2012-135850

(51) Int. Cl. B23D 53/08; B23D 55/08; B23D 59/00; B23D 53/04

(52) U.S. Cl. CPC B23D 53/08; B23D 53/04; B23D 55/088; B23D 59/008
USPC 83/56; 83/794

(57) ABSTRACT

The present invention is directed to a horizontal band saw machine capable of efficiently severing H-beams without a trouble of saw blade's pinching in the kerf. In the horizontal band saw machine, a saw blade (21) can sever one of flanges 20a that has been cut first in an H-beam (20), completely from top to bottom, prior to approaching the center of a web 20b and its vicinity.

### TECHNICAL FIELD

The present invention relates to methods of efficiently severing H-beams by horizontal band saw machines without causing a trouble of saw blade's pinching in the kerf, and the present invention also relates to a control unit and a horizontal band saw machine used for the same.

### BACKGROUND ART

In a machining process where a band saw machine or a circular saw machine is used to severing H-beams, especially wide and long H-beams suitable for a building material, into pieces of steel stock having a predetermined length, often caused is “pinching” in which a saw blade is bound by the opposite machined surfaces defining the kerf. Saw blade pinching once caused prevents the saw blade from moving, and makes the cutting operation impossible any further, and hence, it is strongly desired to avoid the pinching without fail.

Such saw blade pinching is prone to occur in the following manner: H-beams have a great reserve of internal stress that is grown by pressure applied thereto by pressure rollers during its manufacturing process. Such internal stress is released when a saw blade makes a kerf 22 during severing the H-beam as shown in FIG. 8 (A), which gives a stress releasing effect on the machined surfaces in a web 20b, resulting in the machined surfaces swelling. The machined surfaces thus swelled narrows the kerf 22, and then, the saw blade 21 is squeezed in the narrowed kerf 22, which is referred to as “pinching.”

In order to avoid pinching, in general, the saw blade 21 has the “set,” as shown in FIGS. 7 (B) and (C), having its saw teeth L and R bent out on either of left and right sides to widen the kerf 22 over the thickness of the saw body. To make the saw have the set, triplets of saw teeth along a longitudinal dimension of the saw blade 21, namely, the center teeth C and adjacent ones L and R on their respective left and right are arranged so that the left and right teeth alternately extend outward on the left and the right on both sides of the center teeth that are not bent out. In this way, if the machined surfaces swell to some extent, the saw blade would not be pinched in the kerf thus devised to widen.

Typical workpieces that are more likely to cause pinching include H-beams like an H-beam 20 used as a building material as shown in FIG. 1. Because of a recent increasing demand for enhanced load capacity of building materials, the H-beam 20 has an increasingly broader web 20b. In cutting such an H-beam with the broader web, when the saw blade cuts upper portion of the flange 20a and some length in right portion of the web 20b no pinching occurs, and the saw blade continues to cut the web 20b together with the remaining lower portion of the flange, the machined surfaces swell more as the saw blade comes closer to the middle of the web 20b where it has a greater reserve of compressive internal stress. When an amount of swelling is greater than a clearance of the set, the body of the saw blade 21 is squeezed by the machined surfaces and pinched in the narrowed kerf, and it can no longer cut the workpiece.

Various measures have been suggested so far to avoid pinching. For instance, a technology disclosed in Japanese Official Gazette of Preliminary Publication of Unexamined Patent Application No. H10-43936 (Patent Document 1) is a method of avoiding saw blade pinching in which a saw blade that is about to be pinched can controllably interrupt saw blade feeding, backs up by a predetermined amount, and then, resumes the saw blade feeding. Whether the saw blade is about to be pinched or not is determined by detecting a current increase in a motor that drives a blade-driving wheel.

Another technology disclosed in Japanese Official Gazette of Preliminary Publication of Unexamined Patent Application No. H09-70713 (Patent Document 2) is an H-beam cutter having three independent circular saw blades which are controlled for coordinate cutting movements during severing an H-beam, namely, the opposite upright flanges and the horizontal web therebetween so as not to interfere with one another and not to be pinched in kerfs.

### LIST OF CROSS-REFERENCED PRIOR ART DOCUMENTS

### Patent Document

### Patent Document 1

Preliminary Publication of Unexamined Patent Application No. H10-43936

### Patent Document 2

Preliminary Publication of Unexamined Patent Application No. H09-70713

### SUMMARY OF THE INVENTION

### Technical Problem

In the technology described in Patent document 1, a target point at which a saw blade is prone to be pinched and a level of current flowing in the motor at the very moment when the blade-wheel driven by the motor forces the saw blade to approach the target point are predetermined and stored in advance, and numerical data thus stored are compared with an actual position of the saw blade in cutting service and a measurement of the current of the motor. When it is determined that the saw blade is about to be pinched, the saw blade is instructed to interrupt saw blade feeding and back up by a predetermined amount, and then, to resume the saw blade feeding so as to widen the kerf, thereby avoiding saw blade pinching. This technology described in Patent Document 1 cannot be a radical solution effective to thoroughly overcome the trouble of pinching but a mere makeshift in which the saw blade is futilely to repeat going up and down to cope with the pinching, which should unavoidably bring about a reduction in efficiency of the cutting operation. The level of current is unstable, and erroneous detection of it may allow the saw blade to get stuck, which in turn often leads to a trouble of damaging the saw blade.

Meanwhile, in the technology described in Patent Document 2 where more than one circular saw blades are used, a sequence control of the cutting movements makes it possible to prevent any of the saw blades from pinching. With a triple-blade circular saw machine, however, three of the saw blades are simultaneously to be moved along a single machined plane, and this necessitates complicating a structure of the machine and then its control as well as price of the circular saw blades.

As has been discussed, no effective solution to thoroughly cope with the pinching have been found.

Accordingly, it is an object of the present invention to provide a method of efficiently severing H-beams by horizontal band saw machine so as to prevent a saw blade from pinching in a narrowed kerf of workpiece that is being severed, and also provide a control unit and a horizontal band saw machine.

### Solution to Problem

The present invention will now be described to provide a solution to the aforementioned problem in the art.

As well known in the art, the H-beam 20 schematically illustrated in FIG. 1 is a steel material that has a pair of flanges 20a laterally opposite to each other and a web 20b horizontally connected therebetween to be a shaped unit. Such an H-beam 20 is fabricated from ingot having a primary stock shape by using pressure rollers in stages to roll the ingot in a continuous process. Being rolled, the H-beam 20 comes to have a great reserve of internal stress.

FIG. 2 illustrates the internal stress distribution of the H-beam. As can be seen from the figure, the internal stress, developed in the web 20b and the flanges 20a in their respective middle and center sections, is equal to 200 N/mm² or even greater, and it is smaller as the point of development is closer to their respective opposite terminal ends. The internal stress developed in the web 20b is compressive stress while that developed in the flanges 20a is tensile stress. In general, the saw blade tends to be pinched at a point in the kerf where the compressive internal stress is 200 N/mm² or even greater, and the saw blade cutting the H-beam with a broader web encounters a trouble of pinching when it reaches the center of three ⅓ sections in the web 20b. The flanges 20a having tensile stress do not cause the saw blade to be pinched in the course of cutting.

In a prior art horizontal band saw machine in operation for cutting the H-beam 20, as shown in FIG. 9, the saw blade 21 has its one side raised so that its cutting edge meet the horizontal plane at a fixed slant angle θ, ranging approximately from 6° to 10°. A saw frame 7, keeping tilted to make the fixed slant angle θ, is forced to go up and down. The reason why the saw blade 21 is not set horizontal or not almost horizontal but should be tilted to keep the “fixed slant angle θ” to the horizontal plane is that the saw blade 21 set almost horizontally would have its cutting edge length (i.e., a length of the saw blade actually in touch with the workpiece) excessively varied from the flange(s) 20a to the web 20b, and such machining is unreasonable and inefficient.

Inclination at the “fixed slant angle θ” ranging from 6° to 10° is devised for the purpose of leveling the cutting edge length throughout the workpiece. Desirably, the angle θ is sufficiently great, but height h of a bed 3 cannot be accordingly so great in view of operator's convenience and the versatility of the band saw machine. Specifically, the slant angle θ excessively large causes the lowest portion of the saw frame 7 recognized on the right of the FIG. 9 viewing plane to bump against the base before completely cutting the corresponding portion of the workpiece. Hence, the slant angle θ is suppressed as small as 10° or so.

Referring now to FIG. 3, it is assumed, for example, that the H-beam 20 is to be severed in the horizontal band saw machine where the saw blade 21 is inclined to make the slant angle θ as large as 10°, and the saw blade 21 would not encounter pinching in the kerf in a workpiece section of lower internal stress (i.e., the right one-third of the total width of the web 20b) till the body of the saw blade 21 reaches the center of the web 20b and its vicinity. Meanwhile, when it reaches the remaining workpiece section of higher internal stress, or around the center of the web 20 b (i.e., in the middle one-third) of 200 N/mm² or even higher in internal stress, the saw blade 21 gets stuck in the kerf (the section of concern is defined by inclined two parallel chain double-dashed lines in FIG. 3).

The present invention is made in the light of such an advantage that the trouble of pinching would not happen while the saw blade is cutting the sections laterally extended from the center of the web 20b and its vicinity section, and the inventive theory will be discussed below:

1. While still continuing to cut the web 20b, in the section slightly short of the center and its vicinity of higher internal stress, namely, the section of lower internal stress where the pinching is not to be caused, the saw blade completes vertically severing one of the flanges that has been cut first.

2. Then, the web 20b acts to release the internal stress reserved therein, resulting in the kerf 22 being widened as shown in FIG. 8(B), which in turn induces the web 20b to release the internal stress from the section of higher internal stress in the center and its vicinity.

3. After that, sawing is continued in a condition that the machined surfaces defining the kerf 22 no longer make the saw blade be pinched in the narrowed kerf, and thus, the sawing is completed without trouble.

The tactics for applying this theory to actual horizontal band saw machines to put it into practice will be provided below:

One end of the saw frame is considerably raised to steeply incline the saw blade (e.g., to make a slant angle as large as 20° to 30°), and with the saw blade thus inclined, one of the flange is severed thoroughly from top to bottom. In the course of severing thus far, the web also has its some segment cut, but the segment has only lower internal stress, then the saw blade is not pinched. When one of the flanges is severed completely, the web releases the internal stress that causes the machined surfaces to pinch the body of the saw blade therebetween, and immediately results in the kerf 22 being widened to have a width varying from b to c, as shown in FIG. 8 (B). Thus, at this point of time, the saw frame has its raised one end lowered reducing the slant angle (e.g., down to 10° to 5°) while the remaining segment of the web 20b and the other flange 20a are continuously being cut. During this procedure, the web 20b that has already released the internal stress no longer causes the saw blade to be pinched in the kerf till the complete end of the severing.

The tactics as discussed above, unlike the prior art methods, ensure that the pinching of the saw blade is avoided and that H-beams are efficiently severed. In addition, since the cutting edge length throughout the entire profile of the H-beam is considerably leveled more, the resultant cutting efficiency of the saw blade is enhanced, and the reduced frictional heat generation in the cutting edge brings about a significantly increased lifetime of the saw blade.

### BRIEF DESCRIPTION OF THE ACCOMPANYING DRAWINGS

FIG. 1 is a perspective view showing an H-beam being cut,

FIG. 2 is a sectional view showing the H-beam with graphs superposed to illustrate the internal stress distribution of actual measurements,

FIG. 3 is a sectional view showing the H-beam being cut in a horizontal band saw machine,

FIG. 4A is a schematic perspective view showing an exemplary horizontal band saw machine according to the present invention,

FIG. 4B is a front elevational view showing the horizontal band saw machine according to the present invention,

FIG. 5 is a sectional view showing the H-beam being cut in several sequential procedures in the horizontal band saw machine according to the present invention,

FIG. 6 is a flow chart illustrating a cutting method in the horizontal band saw machine according to the present invention,

FIG. 7 depicts a saw blade where FIG. 7(A) is a side view of the saw blade, FIG. 7(B) is a bottom view illustrating the cutting edge of the saw blade, and FIG. 7(C) is a sectional view of the saw blade taken along the line X-X in FIG. 7(A),

FIG. 8 is a plan view showing a kerf in the H-beam from which the saw blade that has cut it halfway through is removed where FIG. 8(A) depicts a right flange still not completely severed to the bottom while FIG. 8(B) depicts the right flange completely severed to the bottom, and

FIG. 9 is a plan view showing a prior art embodiment of the horizontal band saw machine having its cutting component inclined at a fixed angle.

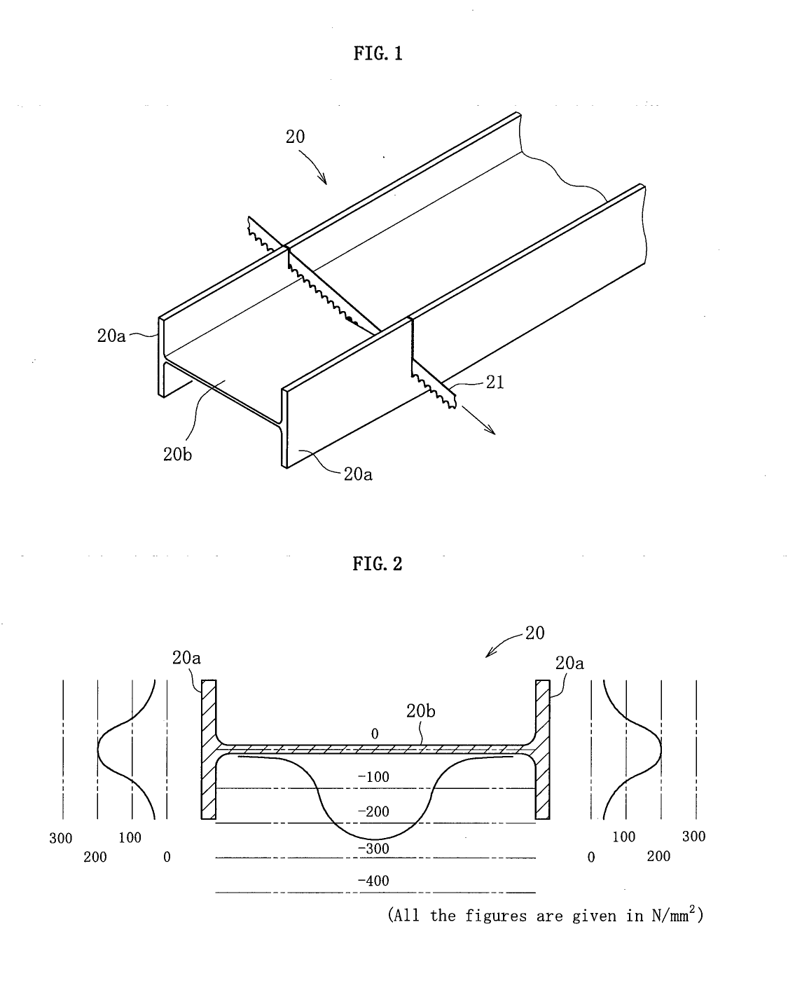

### BEST MODE OF THE INVENTION

With reference to the accompanying drawings, the present invention will now be described in the context of embodiments of a horizontal band saw machine, a severing method in the horizontal band saw machine, and a control unit for the same.

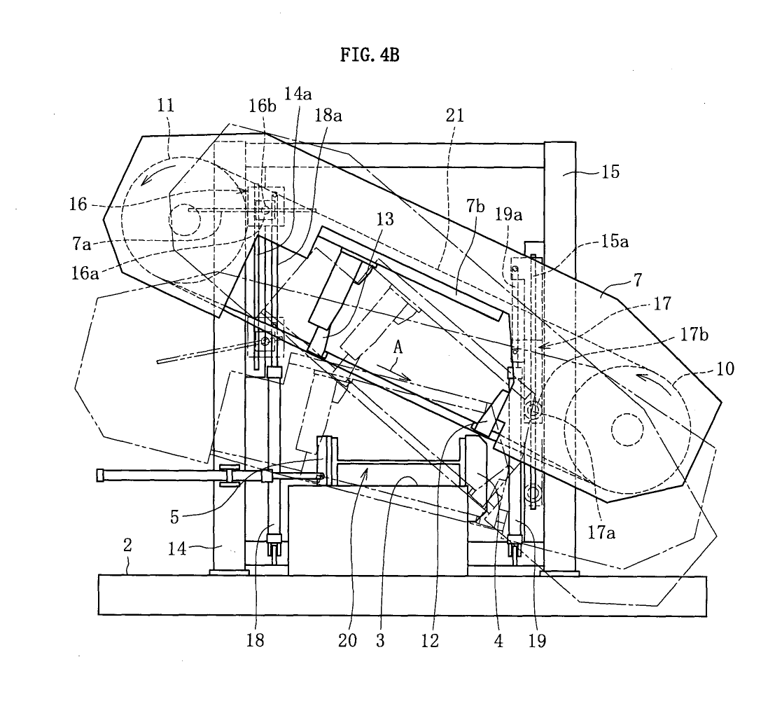

As shown in FIGS. 4A and 4B, a horizontal band saw machine 1 comprises a base 2 and a horizontal bed 3 residing on the base 2 to hold workpiece such as an H-beam 20 thereon, and a pair of a stationary vice jaw 4 and a movable vice jaw 5 adapted to clamp the H-beam 20 from the laterally opposite sides on the bed 3.

In addition, two guide pillars 14 and 15 are laterally opposed to each other on the base 2 and built with some other components to be like a joint beam, and the guide pillars 14 and 15 have their respective linear rails 14a and 15a along the inner longitudinal extensions. Left and right up-and-down plates 16 and 17 are interlocked respectively with the linear rails 14a and 15a by linear blocks (not shown) interposed therebetween, and both the up-and-down plates 16 and 17 are held by a pair of laterally opposed hydraulic cylinders 18 and 19 at top ends of their respective rods 18a and 19a so as to serve as an up-and-down actuator upright along the longitudinal extensions of the guide pillars 14 and 15.

The right up-and-down plate 17 has, in the front face, a pivot shaft 17a planted in a direction orthogonal to the viewing plane of the drawing, and the pivot shaft 17a engaged with a metal 17b at a lower right portion of a laterally elongated saw frame 7 holds the saw frame 7 and permits the saw frame 7 to pivotally move up and down on the left.

On the other hand, the saw frame 7 has, in a left portion of the rear face, a linear rail 7a extended laterally, and a saw frame holder plate 16a is interlocked with the linear rail 7a by a linear block (not shown) interposed therebetween. The saw frame holder plate 16a has, in the rear face, a pivot shaft 16b planted in a direction orthogonal to the viewing plane of the drawing, and the pivot shaft 16b is engaged with the left up-and-down plate 16. The pivot shaft 16b, holding the saw frame 7 at its left portion, permits the saw frame 7 to pivotally move up and down on the right and also prevents it from vibrating fore and aft.

A saw drive wheel 10 is disposed in the right portion within the saw frame 7 while a follower saw wheel 11 is disposed in the left portion within the same. An endless saw blade (band saw blade) is wound around and extended between two of the saw wheels 10 and 11, and a drive motor (not shown) linked to a rotary shaft for the drive saw wheel 10 is actuated to make the saw blade 21 run in a direction indicated by an arrow A in FIG. 4B.

A stationary saw guide 12 is disposed in the right portion of the saw frame 7 above the stationary vice jaw 4. A movable saw guide 13 is also disposed in a position above the movable vice jaw 5, and the movable saw guide 13 extends downward to the lower center zone of the saw frame 7 so as to be movable along the rail 7b that is laterally extended. Two of the saw guides 12 and 13, although the former is fixed and the latter is movable, support the saw blade 21 so that the saw blade 21 has its cutting edge faced downward and stream stably.

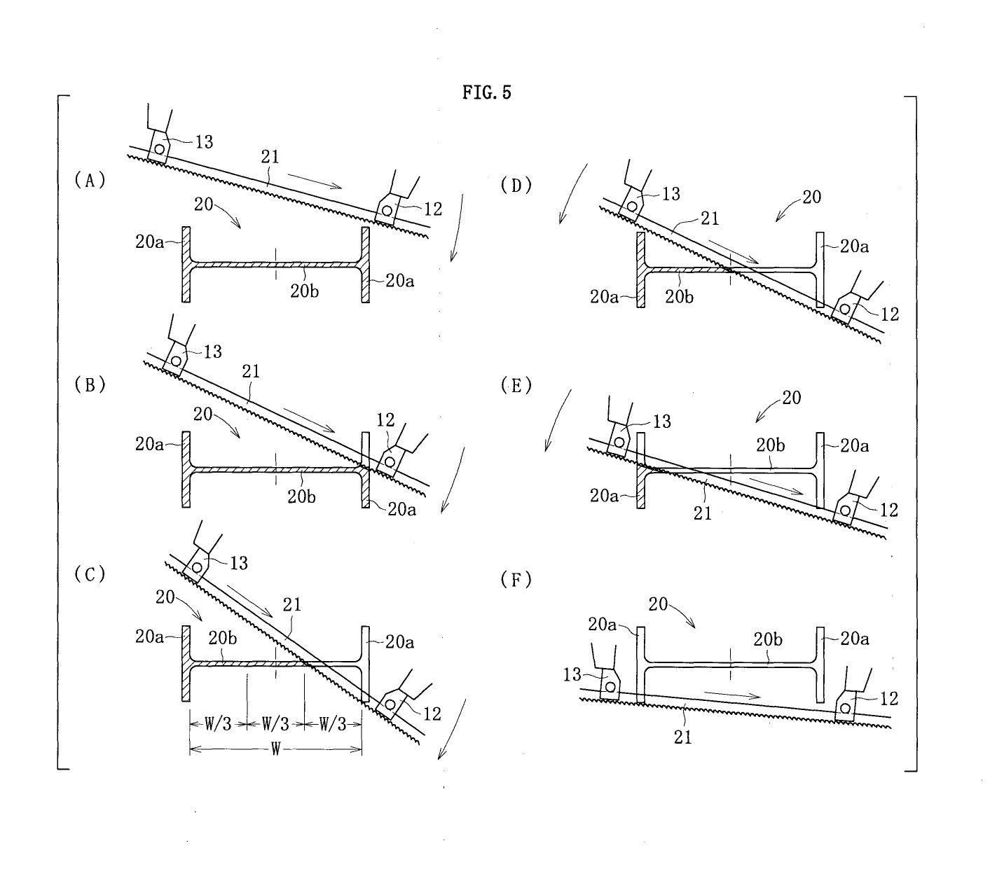

The horizontal band saw machine 1 of the present invention is structured almost as mentioned above, and the method of severing the H-beam in this horizontal band saw machine 1 will now be described step by step, with reference to FIG. 5 (A) to (F).

In advance of severing, as can be seen in FIG. 4B, the H-beam 20 is clamped with the laterally opposite sides by the vice jaws 4 and 5 on the bed 3, and has its right flange 20a cut halfway through from the top, as depicted in FIGS. 5 (A) and (B). During these stages of severing, the left up-and-down plate 16 is retained at a certain level, and the right up-and-down plate 17 alone is lowered. More specifically, the saw frame 7 having the saw blade 21 attached thereto pivots on the pivot shaft 16b engaged with the left up-and-down plate 16 and descends to saw the upper half of the right flange 20a (1st procedure).

Subsequent to cutting the upper half of the right flange 20a, as depicted in FIGS. 5 (B) and (C), the saw frame accesses the lower half of the right flange 20a and the right segment of the web 20b to concurrently cut them. At this point, also, the left up-and-down plate 16 is still retained at a certain level, and the right up-and-down plate 17 alone is lowered. In this way, the slant angle made by the tilted saw blade 21 becomes considerably large immediately before the right flange 20a is completely severed, and since the right segment of the web 20 that has been sawed so far is still within the section of lower internal stress, the saw blade is not pinched in the kerf (2nd procedure).

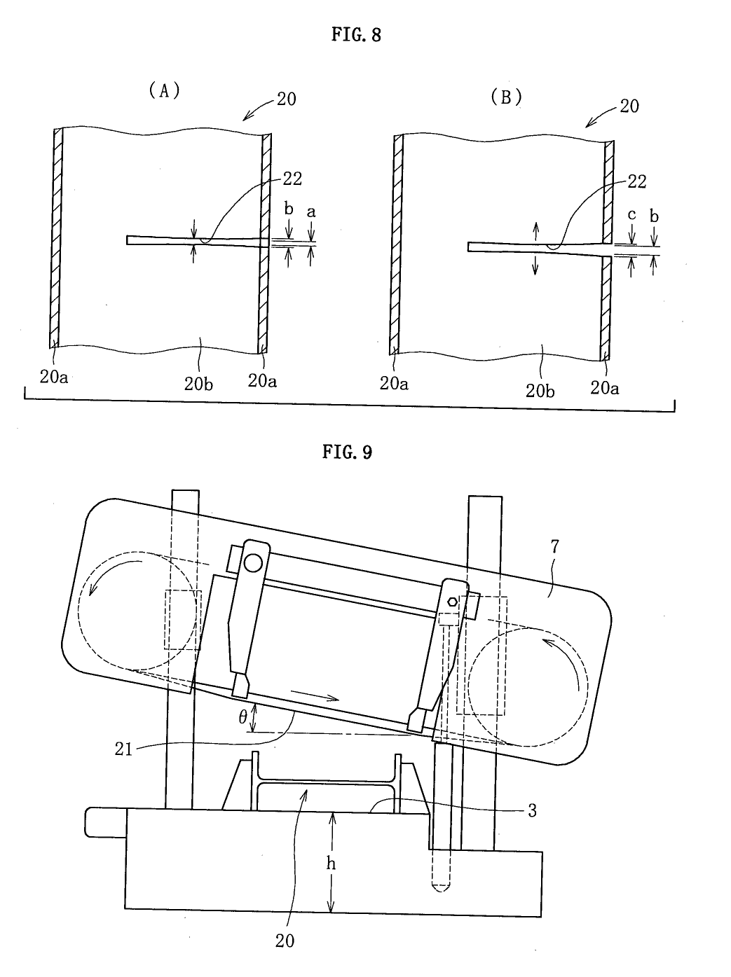

In simultaneous with completely severing the right flange 20a to the bottom end as can be seen in FIG. 5 (C), the web 20b releases the internal stress, and the kerf 22 is widened as indicated by arrows in FIG. 8 (B). After this period, the saw frame 7 starts to recover a gentle inclination posture, thereby permitting the saw blade to cut the remaining portion of the web 20b and the left flange 20a without the trouble of pinching. In this stage, the right up-and-down plate 17 is halted in the current position, and instead, the left up-and-down plate 16 alone is lowered. The saw frame 7 together with the saw blade 21, turning on the pivot shaft 17a planted in the front face of the right up-and-down plate 17, descends as depicted sequentially in FIGS. 5 (D), (E) and (F) till completely severing the H-beam 20 (3rd procedure).

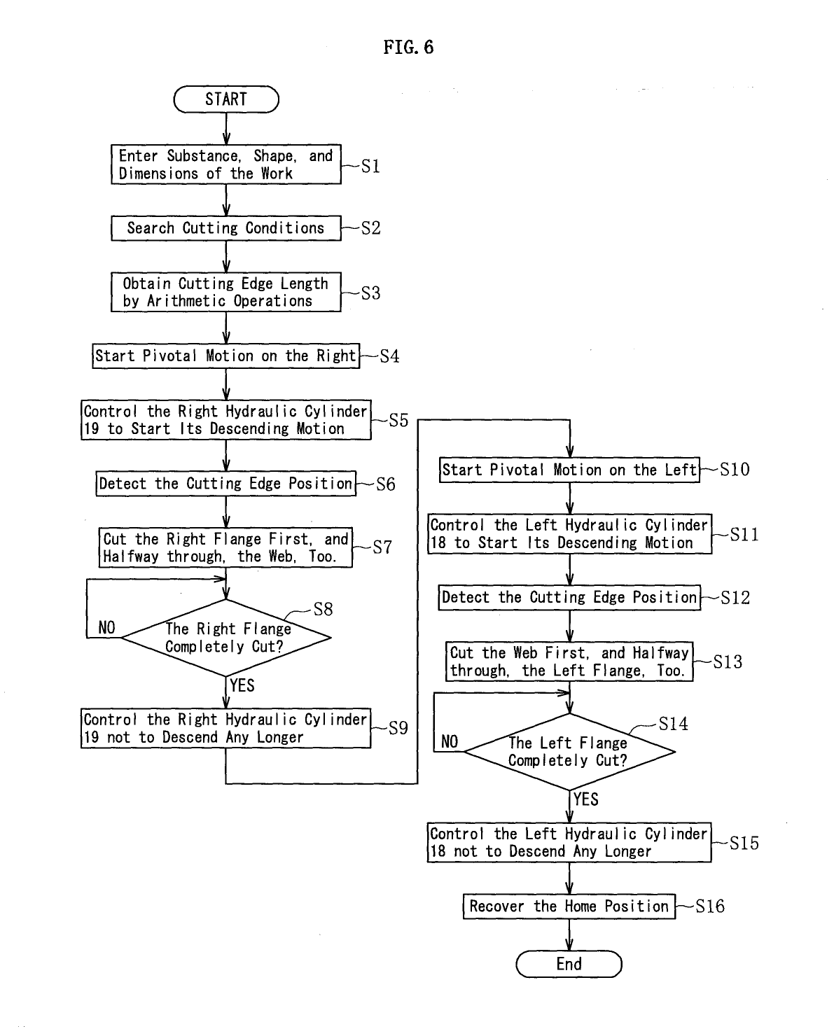

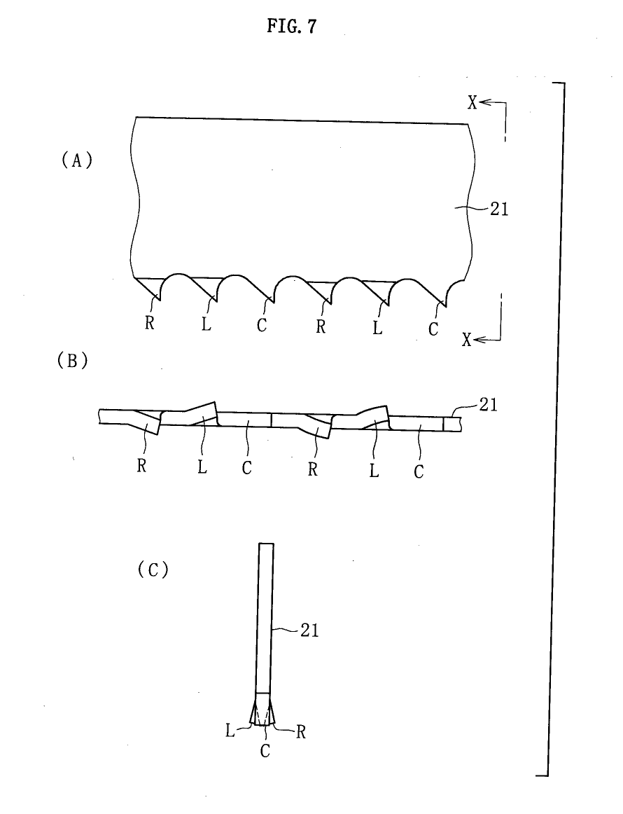

The severing procedures depicted in FIG. 5 can be carried out as commanded in Steps S1 to S16 in the flow chart of FIG. 6. This flow chart is stored in a form of computer executable program in a control unit 25 of the horizontal band saw machine 1 in FIG. 4A; and initially, in Step S1, material, shape, and dimensions of work such as H-beam are entered to the control unit 25 incorporated in the horizontal band saw machine 1 in FIG. 4A. The control unit 25 stores control parameters in advance for the left and right hydraulic cylinders 18 and 19, the drive saw wheel 10, and the like in relation with material, shape, and dimensions of H-beams, and in Step S2, the optimized cutting conditions are sought according to the entered data above mentioned.

Then, after calculating in Step S3 cutting edge length of the saw blade 21 in the flange 20a and the web 20b corresponding to the varying blade edge position, the saw frame 7 begins pivotal motion on the right in Step S4, and then, the right hydraulic cylinder 19 begins descending (shortening) under control in Step S5. When a blade approach position where the saw blade 21 is first to chip in work is detected in Step S6, the saw blade 21 starts cutting the upper half of the right flange 20a in Step S7, which is the end of the 1st procedure. Continuously, the saw blade 21 cuts the lower half of the right flange 20a, and halfway through, the web 20b, too.

In Step S8, it is determined whether or not the right flange 20a has been severed, and if so (i.e., the severing is completed), the right hydraulic cylinder 19 is controlled not to descend any longer in Step S9, which is the end of the 2nd procedure. Next, in Step S10, the saw frame 7 starts pivotal motion on the left, and the left hydraulic cylinder 18 starts descending (shortening) under control in Step S11.

Then, another blade approach position where the saw blade 21 is to chip in work is detected in Step S12. Continuously, the saw blade 21 cuts the web 20b, and halfway through, the left flange 20a, too. In Step S14, it is determined whether or not the left flange 20a has been severed, and if so (i.e., the severing is completed), the left hydraulic cylinder 18 is controlled not to descend any longer in Step S15, which is the end of the 3rd procedure. Next, in Step S16, both of the left and right hydraulic cylinders 18 and 19 recover their respective home positions.

In prior art severing methods, typically, the saw blade 21 is tilted to keep the slant angle fixed at 10° or smaller from first to the end of the severing process, or one end of the saw frame is hinged for pivotal motion to descend the saw blade. Either manner may permit the body of the saw blade to reach the center of the web 20b or its vicinity prior to completely severing one of the flanges of H-beam, and there is every possibility that the saw blade 21 gets stuck in the kerf. Moreover, the slant angle fixed at 10° or smaller means that the saw blade tilted so gently has its cutting edge length greatly varied from one portion of work to another, being shorter for the flanges and being longer for the web, which brings about a poor cutting efficiency.

In accordance with the present invention, as capable of tilting sufficiently steeply, the saw blade 21 can completely sever the flange 20a before the body of the saw blade 21 reaches the center of the web 20b or its vicinity where internal stress is higher, and thus, it is perfectly avoidable for the saw blade to be pinched in the kerf. The greater slant angle means the saw blade 21 has its cutting edge length extended for the flange 20a and reduced for the web 20b, or has its cutting edge lengths in the flange 20a and the web 20b considerably equalized each other throughout workpiece, and the resultant cutting efficiency of the saw blade is enhanced, which brings about an increased lifetime of the saw blade.

The slant angle made by the cutting edge of the saw blade tilted (maximally tilted) at the very moment when it has completely severed the right flange 20a is desirably 30° or even larger, and this may be appropriately modified depending upon the dimensions of the H-beam that is to be severed.

As has been described, immediately after the right flange 20a has been severed, the right up-and-down plate 17 is halted at the current level while the left up-and-down plate 16 is lowered so that the saw frame 7 pivots to cut the remaining portion of the H-beam, and hence, the bed 3 do not have to change from its usual height. In this way, operator's convenience and the versatility of the band saw machine can be ensured.

Although this embodiment employs “pivotal movement” of the saw frame 7 during cutting the right flange 20a in such a manner that the saw frame 7 has its left end fixed in position so as to not descend and its right end lowered, it is obvious that “fixed slant movement” may be an alternative in such a manner that the saw frame 7, keeping tilted at the same angle as it has been since the right flange 20a was completely severed, is lowered.

In addition, although, in this embodiment, the hydraulic cylinders are used as actuators to make both the right and left up-and-down plates 16 and 17 go up and down, an exclusive use of the hydraulic cylinders is not intended, and any other actuator (e.g., ball screw) may be substituted so far as it is capable of making the up-and-down plates 16 and 17 go up and down.

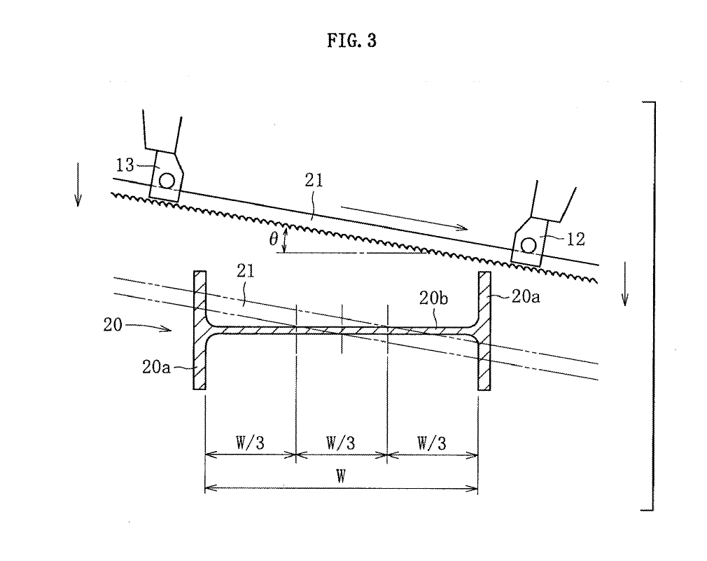

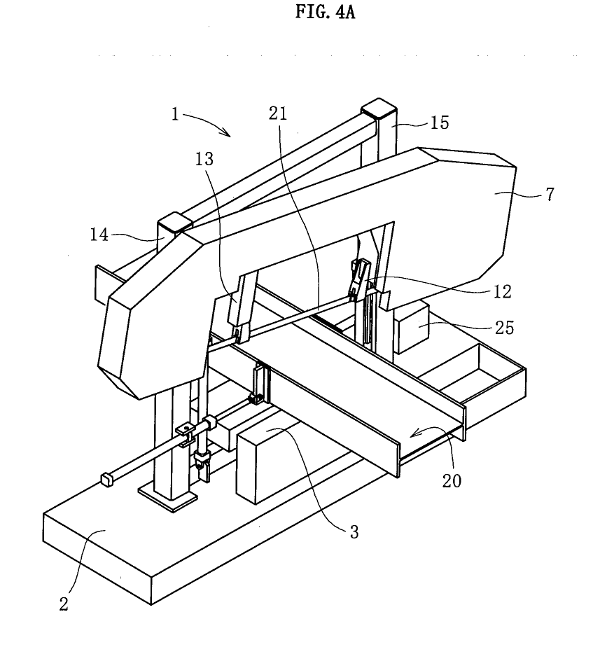

The terms that have been used so far will now be explained. The “center” of the web 20b should cover a zone dividing a widthwise dimension of the web 20b into two parts as well as its contiguous zones bilaterally extended to some extent, and the extension maximally possible is designated as W/3 in the middle illustrated in FIG. 3. The middle W/3 section is of higher internal stress that is prone to cause the saw blade to be pinched.

The horizontal band saw machine according to the present invention drastically eliminates every possibility to cause a saw blade to be pinched in the kerf as mentioned above, and hence, the cutting velocity can be increased up to twice as high as the prior art band saw machines. Also, in this method, the saw blade is inclined steeply in the course of severing to considerably level its cutting edge length throughout the profile of the H-beam, and thus, the resultant cutting efficiency of the saw blade is enhanced, and the reduced frictional heat generation in the cutting edge guarantees a significantly increased lifetime of the saw blade.

### REFERENCE SIGNS LIST

2 Base
3 Bed
4 Stationary Vice Jaw
5 Movable Vice Jaw
7 Saw Frame
7b Rail
7a Linear Rail
10 Drive Saw Wheel
11 Follower Saw Wheel
12 Stationary Saw Guide
13 Movable Saw Guide
14 Guide Pillar
14a Linear Rail
15 Guide Pillar
15a Linear Rail
16 Left up and down Plate
16a Saw Frame Holder Plate
16b Pivot Shaft
17 Right up and down Plate
17a Pivot Shaft
17b Metal
18 Left Hydraulic Cylinder
18a Rod
19 Right Hydraulic Cylinder
19a Rod
20 H-beam
21 Saw Blade

1. A method of transversely severing metal work such as H-beam with a saw blade in a horizontal band saw machine, the H-beam having a pair of flanges laterally spaced from each other and a web horizontally connected therebetween to be a shaped unit, comprising the steps of
cutting the upper half of one of the flanges first by the saw blade attached to a saw frame in the horizontal band saw machine, one end of the saw frame being raised so that the saw blade keeps steeply tilted during cutting,
cutting the remaining lower half of the flange and the web concurrently by the saw blade, the flange being completely severed from top to bottom before the saw blade reaches approximately the center of the web, and
cutting the remaining portion of the web and the other of the flanges.

2. The method according to claim 1, wherein the steps of cutting the upper half of one of the flanges first and of cutting the remaining lower half of the flange include lowering the saw blade while it is tilted more steeply than before or it keeps the same steep inclination.

3. The method according to claim 1, wherein succeeding to the step of cutting the remaining lower half of the flange, the step of cutting the remaining portion of the web and the other of the flanges include making the saw blade recover gently tilted posture.

4. A control unit incorporated in a horizontal band saw machine that has a saw frame with a saw blade attached thereto and a pair of up-and-down actuators disposed to support the saw frame on the laterally opposite sides, for controlling the pair of the up-and-down actuators to move the saw blade up and down and tilt it under control, comprising the steps of
controlling one of the up-and-down actuators to pivot the saw frame and have its one end moved downward, for cutting the upper half of one of the flanges first by the saw blade, one end of the saw frame being raised so that the saw blade keeps steeply tilted during cutting,
controlling the up-and-down actuator for cutting the remaining lower half of the flange and the web concurrently by the saw blade, the flange being completely severed from top to bottom before the saw blade reaches approximately the center of the web, and
controlling the other up-and-down actuator for cutting the remaining portion of the web and the other of the flanges.

5. The control unit according to claim 4, wherein the steps of controlling for cutting the upper half of one of the flanges first and of controlling for cutting the remaining lower half of the flange include controlling the up-and-down actuator for lowering the saw blade while it is tilted more steeply than before or it keeps the same steep inclination.

6. A horizontal band saw machine comprising the control unit according to claim 4.

7. A horizontal band saw machine comprising the control unit according to claim 5.
